(19) United States
(12) Patent Application Publication
(10) Pub. No.: US 2026/0126666 A1
(43) Pub. Date: May 7, 2026

(54) BESSEL BEAM GENERATION DEVICE AND OPTICAL SCANNING DEVICE USING SAME

(71) Applicant: Hiroshi OGAWA, Yokohama (JP)

(72) Inventor: Hiroshi OGAWA, Yokohama (JP)

(21) Appl. No.: 18/860,002

(22) PCT Filed: Apr. 27, 2023
(86) PCT No.: PCT/JP2023/016779

§ 371 Date: Dec. 17, 2025

(30) Foreign Application Priority Data
Apr. 27, 2022 (JP) 2022-073024

(51) Int. Cl. G02B 27/09

(52) U.S. Cl. CPC G02B 27/0927; G02B 27/0916; G02B 27/0955; G02B 27/0994

(57) ABSTRACT

The modified Bessel beam generating device that achieves design flexibility is provided. The present invention provides a Bessel beam generating device that splits a laser beam emitted from a single light source and causes diverging light in a donut shape from optical fibers arranged on the same circle to be emitted toward the inside, thereby emitting a disk illumination beam that is focused in the vicinity of the center. This makes it possible to generate a disk illumination beam without blocking the high-intensity central portion and without reducing the light intensity.

### TECHNICAL FIELD

The present invention relates to, for example, a Bessel beam generating device having a large depth of focus, and an optical scanning device using the same.

### BACKGROUND ART

Conventionally, an OCT (Optical Coherence Tomography) apparatus that generates a Bessel beam using an axicon lens is known (see, for example, Patent Document 1).

### CITATION LIST

### Patent Literature

PTL1: Japanese Patent No. 5680776

### SUMMARY OF INVENTION

### Technical Problem

However, in an OCT apparatus of such a configuration, because an axicon lens is used, the focal length from the axicon lens to the focus is restrictively short, requiring the distance to the object being irradiated to be set short. This imposes limitations on the design.

The present invention has been made to solve the above problem, and an object of the invention is to provide a Bessel beam generating device and an optical scanning device using the same that can improve design freedom (design flexibility).

### Solution to the Problem

To achieve the above object, a Bessel beam generating device according to the present invention is characterized by comprising: a group of at least four light emitters arranged at equal intervals on the same circle such that light is emitted from the tip of an optical waveguide portion, with the optical axis of the light emitted from each said light emitter maintained at the same angle with respect to the diameter direction of the circle; an entrance portion that splits a laser beam emitted from a single light source and causes the split beams to enter each of the optical waveguide portions; and an optical waveguide portion having a function to make the phase and amplitude of the emitted light from each said light emitter identical.

Further, an optical scanning device according to the present invention is characterized by comprising: a group of at least four light emitters arranged at equal intervals on the same circle such that light is emitted from the tip of an optical waveguide portion, with the optical axis of the light emitted from each said light emitter maintained at the same angle with respect to the diameter direction of the circle; an entrance portion that splits a laser beam emitted from a single light source and causes the split beams to enter each of the optical waveguide portions; an optical waveguide portion having a function to make the phase and amplitude of the emitted light from each said light emitter identical; a light receiving unit that receives return light of the emitted light (reflected from the measurement object) and converts it into an electrical signal; and an analysis unit that calculates the position of a reflection point of the measurement object by analyzing the electrical signal.

Furthermore, a Bessel beam generating device according to the present invention is characterized by comprising: a rotationally symmetric conical reflector whose generatrix is linear or curved with respect to the optical axis such that an incident laser beam is reflected outward relative to the optical axis; and a reflective cover portion arranged to cover the conical reflector, which re-reflects the wave reflected by the conical reflector using an elliptical surface main mirror having the optical axis as its axis of rotational symmetry.

An optical scanning device according to the present invention is characterized by comprising: a light source that emits a laser beam; a reflective lens on which the laser beam from the light source is incident and which reflects the laser beam outward from the optical axis; a reflective cover portion arranged to cover the reflective lens and that reflects the laser beam traveling outward toward the inside, thereby projecting a disk-shaped illumination beam; a light receiving unit that receives return light from the disk illumination beam and converts it into an electrical signal; and an analysis unit that calculates the position of a reflection point of the measurement object by analyzing the electrical signal.

### Advantageous Effects

According to the present invention, it is possible to realize a Bessel beam generating device and an optical scanning device using the same that can improve design flexibility.

### BRIEF DESCRIPTION OF DRAWINGS

FIG. 1 is a schematic diagram illustrating the configuration (1) of a Bessel beam generating device in the first embodiment.

FIG. 2 is a schematic diagram illustrating the configuration (2) of the Bessel beam generating device in the first embodiment.

FIG. 3 is a schematic diagram for explaining the laser light emitted from an optical fiber.

FIG. 4 is a schematic diagram illustrating the configuration (3) of the Bessel beam generating device in the first embodiment.

FIG. 5 is a schematic diagram for explaining (1) the focusing of the Bessel beam generating device in the first embodiment.

FIG. 6 is a schematic diagram for explaining movement of the focus of the Bessel beam generating device in the first embodiment in a plane direction.

FIG. 7 is a schematic diagram for explaining (2) the focusing of the Bessel beam generating device in the first embodiment.

FIG. 8 is a schematic diagram for explaining movement of the focus of the Bessel beam generating device in the first embodiment in the depth direction.

FIG. 9 is a schematic diagram illustrating the configuration of an OCT apparatus in the first embodiment.

FIG. 10 is a schematic diagram illustrating the configuration of a measurement unit in the first embodiment.

FIG. 11 is a schematic diagram illustrating the configuration of a Bessel beam generating device in the second embodiment.

FIG. 12 is a schematic diagram illustrating the configuration of an OCT apparatus in the second embodiment.

FIG. 13 is a schematic diagram illustrating the configuration of a Bessel beam generating device in the third embodiment.

FIG. 14 is a schematic diagram illustrating the configuration of a modification of the Bessel beam generating device in the third embodiment.

### DESCRIPTION OF EMBODIMENTS

Next, embodiments for carrying out the present invention will be described with reference to the drawings.

### First Embodiment

### Configuration of Disk-Shaped Bessel Beam Generating Device

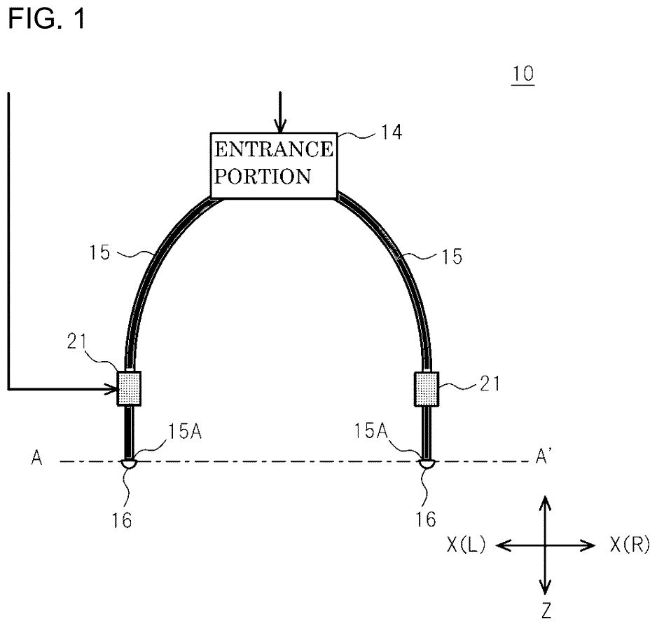

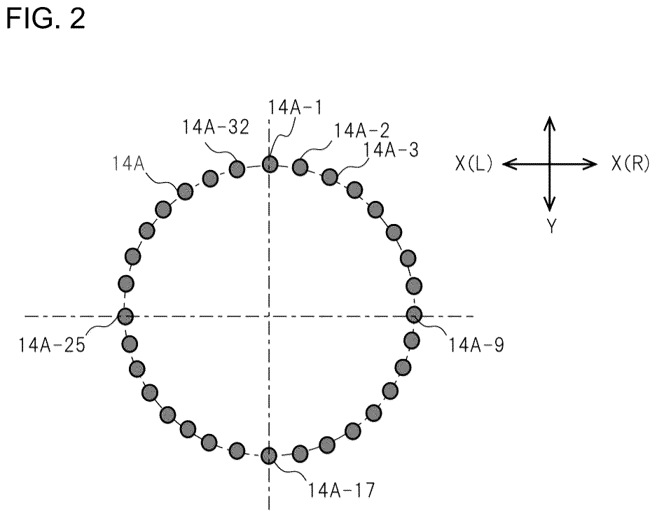

In FIG. 1, reference numeral 10 indicates a disk-shaped Bessel beam generating device. In the disk-shaped Bessel beam generating device 10, as shown in FIG. 2, split beams divided from one light source are made to enter an optical fiber 15 in which fiber tip 15A are arranged on the same circumference. The fiber tip 15A emit, as a disk-shaped Bessel beam, an irradiation beam having a donut-shaped cross-section with its central portion missing (i.e., a hollow center).

Here, a case will be described in which a single light source is split into 32 beams that are injected into 32 optical fiber 15, but the number of split beams is not limited. In order to generate a uniform disk-shaped Bessel beam, it is preferable to use 8 fibers, or more preferably 16 or more fibers.

A light source (not shown) that emits a laser beam is a laser light source for emitting laser light. There is no particular limitation on the wavelength of the laser light, and it is appropriately selected according to the object to be irradiated. For example, if the object to be irradiated is a human body, near-infrared light (780 nm to 2500 nm) is preferably used.

An entrance portion 14 is provided to adjust the beam diameter of the split beams and efficiently couple them into the optical fiber 15. For example, coupling lenses, spherical lenses, rod lenses, or the like are used singly or in appropriate combination.

The optical fiber 15 emits the split beam from its tip, which is the fiber tip 15A. Here, as shown in FIG. 2, the fiber tip 15A are arranged at equal intervals on a circle (indicated by a dashed line).

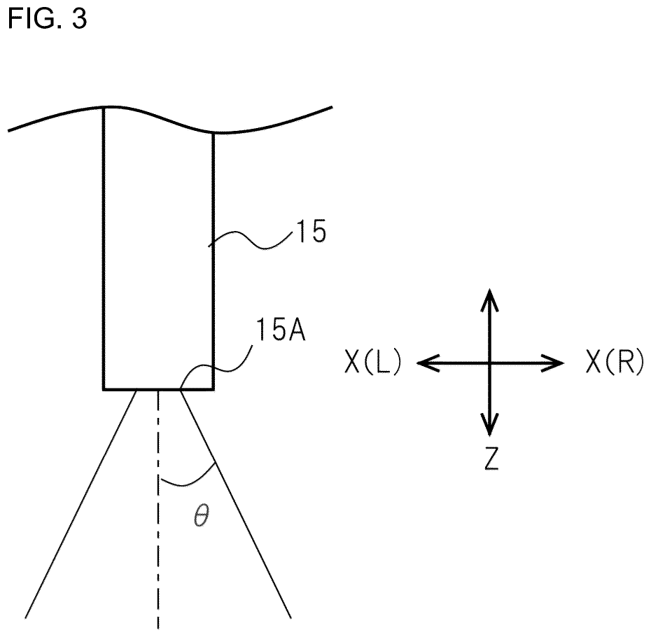

As shown in FIG. 3, the split beams incident into the optical fiber 15 become diverging light with a divergence angle θ determined by the refractive index of the optical fiber, and are emitted from the fiber tip 15A as an irradiation beam. In FIG. 3, the fiber tip 15A is arranged perpendicular to the diameter of the circle; however, for example, it may be arranged tilted inward (tilted at an angle greater than 90° with respect to the diameter of the circle). This tilt angle (the angle between the diameter direction of the circle, as viewed from inside the circle, and the optical fiber 15) is set to be the same for all 32 optical fiber 15.

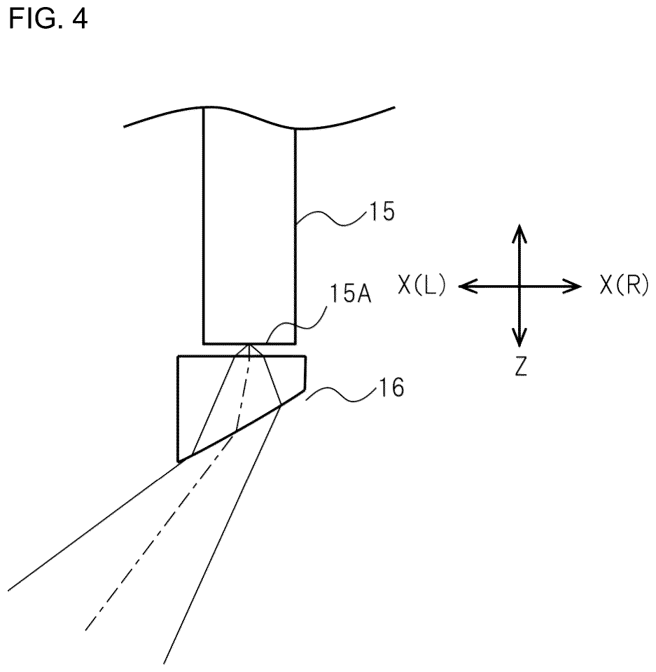

As shown in FIG. 4, a lens 16 is attached to the front end of the fiber tip 15A. The lens 16 adjusts the traveling direction and divergence angle of the irradiation beam. Specifically, the divergence angle in the diameter direction of the circle is adjusted according to the desired depth of focus: when a greater depth of focus is desired, the divergence angle is made larger; when a smaller depth of focus is desired, the divergence angle is made smaller. The traveling direction of each irradiation beam is set according to the focal length: when the focal length is small, the tilt angle with respect to the diameter direction of the circle is small, and when the focal length is large, the tilt angle with respect to the diameter direction of the circle is large.

In the lens 16, the divergence angle of the irradiation beam is adjusted by the shape of the entrance surface and/or exit surface (or a combination of both). For example, if it is desired to increase the NA (Numerical Aperture) of the light beam emitted from the optical fiber 15, a convex lens with a bulging exit surface is suitably used; if it is desired to decrease the NA, a concave lens with a recessed exit surface is suitably used.

The lens 16 can also adjust the polarization direction of the irradiation beam as needed. Note that the lens 16 may be a single lens or a combination of two or more lenses. Here, since the same divergence angle and tilt angle are set for all the irradiation beams, the 32 irradiation beams overlap and combine while diverging and travel toward the center of the circle (travel perpendicular to the circumference), forming one donut-shaped disk illumination beam.

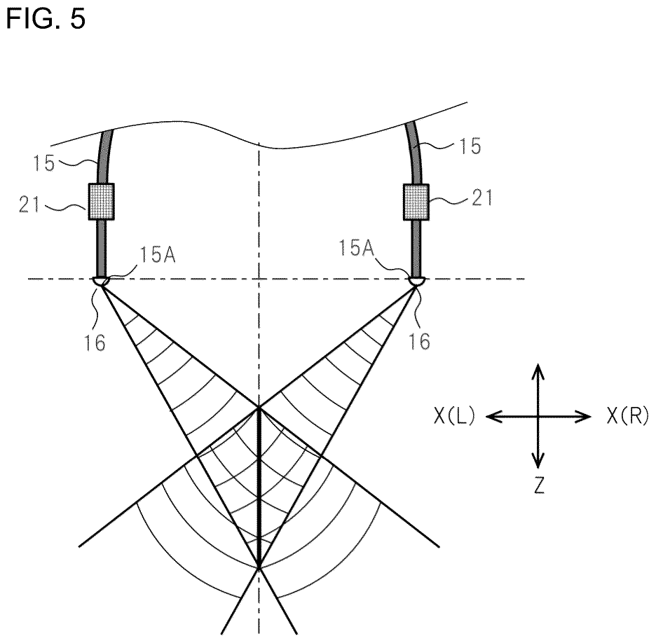

Since split beams with identical optical path lengths from a single light source are incident into the optical fiber 15, the disk illumination beam is focused so that its focal points coincide on the central axis, as shown in FIG. 5. At this time, because a focal point (indicated by a bold line) is formed on the central axis of the diverging disk illumination beam according to the overlap of the beams, it is possible to increase the depth of focus.

It is also possible to provide, just before the tip of the optical fiber 15, a voltage applying unit 21 that applies a voltage. By applying a voltage, the wavelength of the portion to which the voltage is applied can be temporarily changed, allowing the wavefront of the light to be advanced or delayed. Specifically, voltage is applied to half of the optical fiber 15 such that the optical fiber 15 positioned in the direction toward which the focal point is to be shifted has the highest voltage, and the voltage gradually decreases for fibers further away.

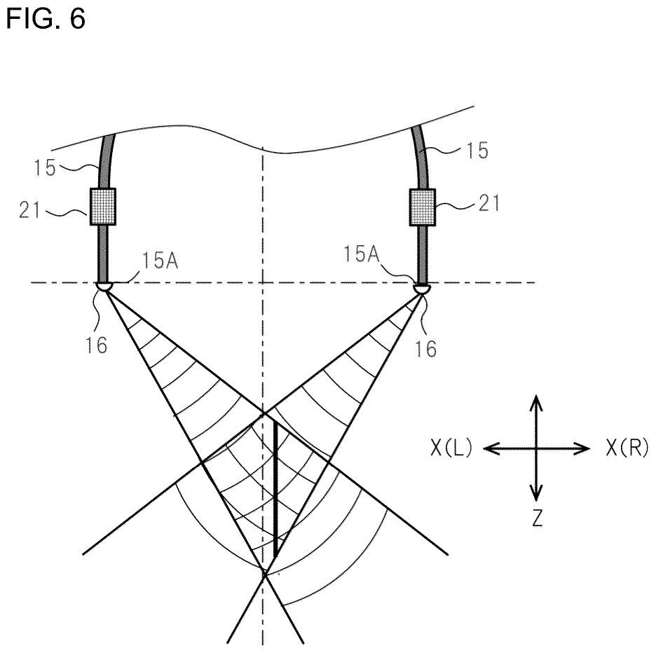

In FIG. 6, by delaying the wavefront on the right side in the X-direction (indicated as X(R) in the figure), the focal position has shifted toward the right side of the page. In other words, to shift the focal position to the right side in the X-direction, voltages are applied to the fibers on the right side in the X-direction (14A-1 to 14A-17). Specifically, the highest voltage is applied to the fiber 14A-9 at the extreme right, and the voltage applied is gradually reduced for fibers toward the left.

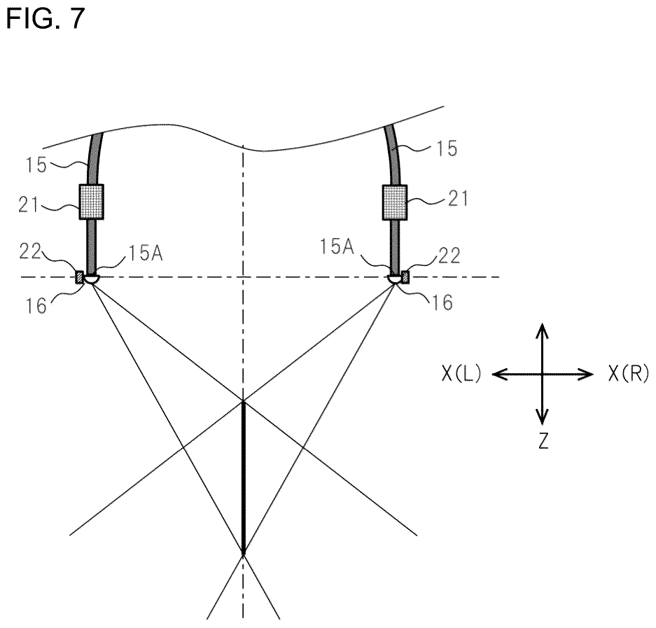

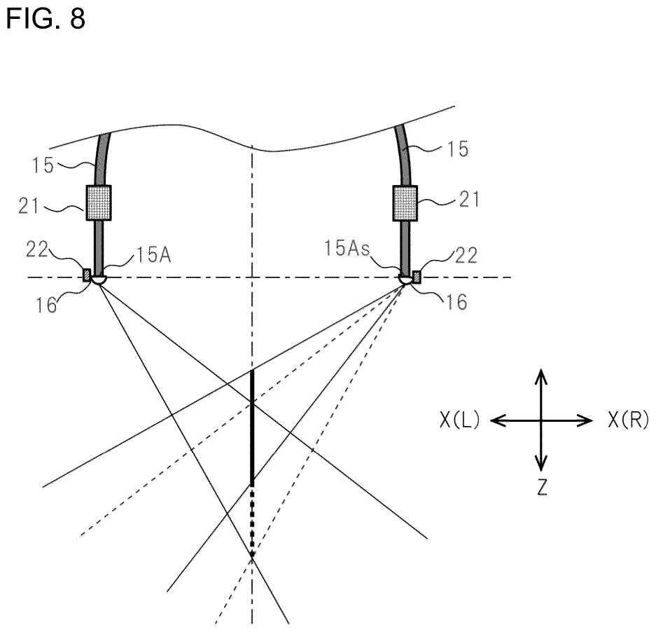

As shown in FIG. 7, it is also possible to provide a lens driving unit 22. As shown in FIG. 8, the lens driving unit 22 displaces the lens 16 so as to change the angle at which the lens 16 is incident relative to the fiber tip 15A. This allows the focal position in the Z-direction (the propagation direction of the disk illumination beam) to be shifted (moved along the optical axis of the disk illumination beam).

### Configuration of Optical Scanning Device

Next, the configuration when the disk-shaped Bessel beam generating device 10 is used as an OCT (Optical Coherence Tomography) apparatus (an example of an optical scanning device) will be described.

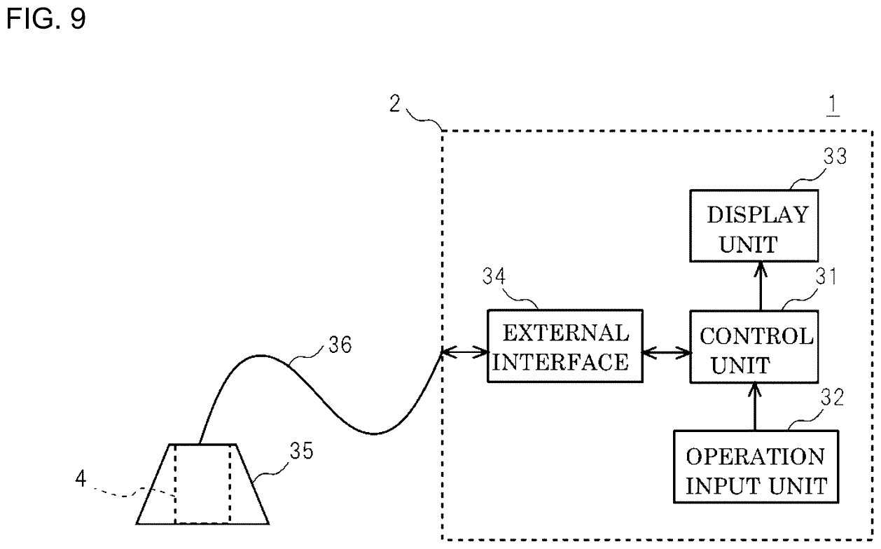

As shown in FIG. 9, an OCT apparatus 1 includes an external device 2 and a measurement unit 4 connected by a line 36. There is no particular limitation on the line 36, and any known wired line capable of telecommunication can be used. Alternatively, a wireless network may be used in place of the line 36.

The external device 2 is provided with a control unit 31 composed of an MPU (Micro Processing Unit), a ROM (Read Only Memory), a RAM (Random Access Memory), etc., which integrally controls the entirety of the external device 2.

The control unit 31 controls a display unit 33 and the measurement unit 4 according to user operation input, and displays on the display unit 33 the measurement results obtained by the measurement unit 4.

Specifically, when an operation input unit 32 supplies a request signal to start measurement, the control unit 31 starts a measurement process and supplies a start signal to the measurement unit 4 via an external interface 34 (displayed as “External I/F” in the figure) and the line 36.

The measurement unit 4 includes a housing 35 with its bottom side exposed, and the measurement unit 4 is housed inside. The start signal is supplied to the measurement unit 4.

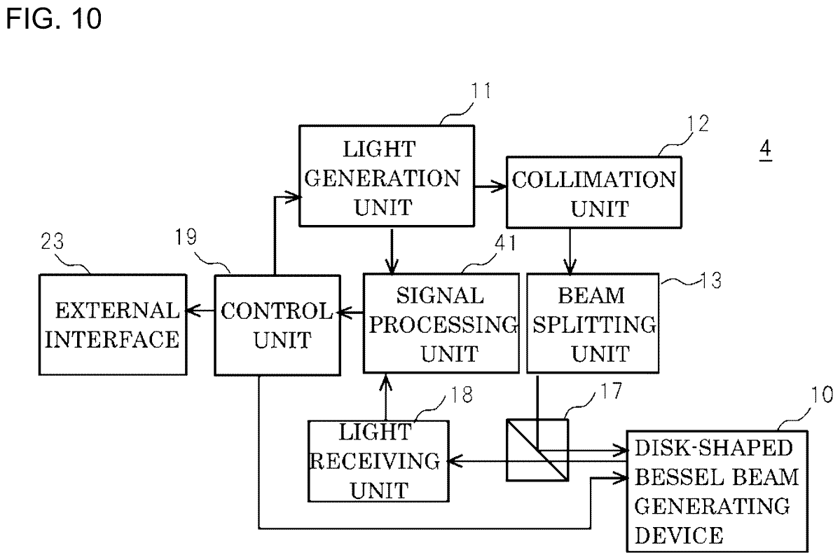

As shown in FIG. 10, the measurement unit 4 is provided with a control unit 19 composed of an MPU, ROM, and RAM, which integrally controls the entirety of the measurement unit 4.

When the start signal is supplied, the control unit 19 causes a light source (not shown) in a light generation unit 11 to emit a laser beam. The light generation unit 11 converts the continuous laser beam emitted from the light source into a pulse beam with frequency modulation using an optical comb, and emits it. At this time, the light generation unit 11 may also perform phase modulation or frequency conversion as needed. Although not shown, the light generation unit 11 supplies to a signal processing unit 41 a detection signal based on a reference light beam whose optical path length has been adjusted such that it is approximately the same as (within the focal range of) the optical path length of the return beam from the measurement target.

The laser beam emitted from the light generation unit 11 is converted into parallel light by a collimation unit 12, and then enters a beam splitting unit 13. The beam splitting unit 13 splits the parallel light into 32 split beams with identical optical path lengths. The beam splitting unit 13 may consist of an optical waveguide on a silicon or quartz substrate enabling optical wiring (such as an arrayed-waveguide grating (AWG)), or a combination of multiple optical elements ( for example, a combination of multiple beam splitters and multiple couplers (isolators), etc., with appropriate use of optical path length adjustment reflectors such as mirrors).

The split beams are directed into the disk-shaped Bessel beam generating device 10 via an optical branching unit 17. Note that a separate optical branching unit 17 may be provided corresponding to each of the 32 split beams, or one optical branching unit may correspond to multiple split beams, or a single optical branching unit 17 may handle all split beams. For the optical branching unit 17, an optical element may be used that allows one of the outgoing light beam and the returning light beam to pass straight and bends the other beam (for example, a half-mirror type non-polarizing beam splitter, a polarizing beam splitter, an isolator, etc.) If a polarizing beam splitter is used as the optical branching unit 17, a quarter-wave plate is placed between the optical branching unit 17 and the lens 16.

The disk-shaped Bessel beam generating device 10 irradiates the measurement target with a disk-shaped Bessel beam as a disk illumination beam.

The disk-shaped Bessel beam generating device 10 also directs the return light beam from the measurement target back into the optical branching unit 17. The optical branching unit 17 directs the return light beam into a light receiving unit 18.

The light receiving unit 18 generates a measurement signal, which is an electrical signal corresponding to the received reference light beam and return light beam, and supplies it to a signal processing unit 41. The signal processing unit 41 is also supplied with a reference signal generated from the optical comb in the light generation unit 11. This reference signal is supplied in synchronization with the timing of the electrical signal generated from the return light beam from the measurement target. The signal processing unit 41 generates a measurement composite signal by combining the measurement signal and the reference signal, and supplies it to the control unit 19.

The control unit 19 supplies the measurement composite signal to the external device 2 via the external interface 23. When the control unit 31 of the external device 2 receives the measurement composite signal via the line 36 and the external interface 34, it analyzes the measurement composite signal to calculate the positions of reflection points in the measurement target, generates image data, and displays it on the display unit 33.

### Second Embodiment

### Configuration of Disk-Shaped Bessel Beam Generating Device

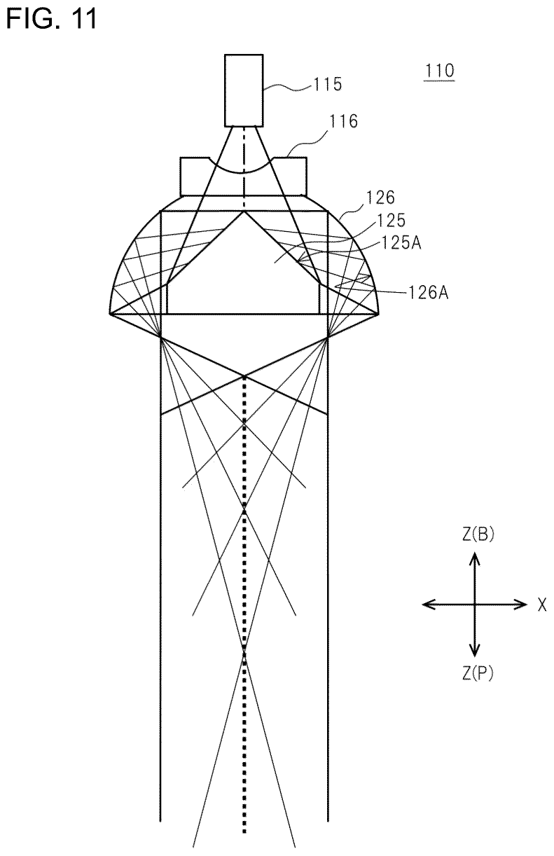

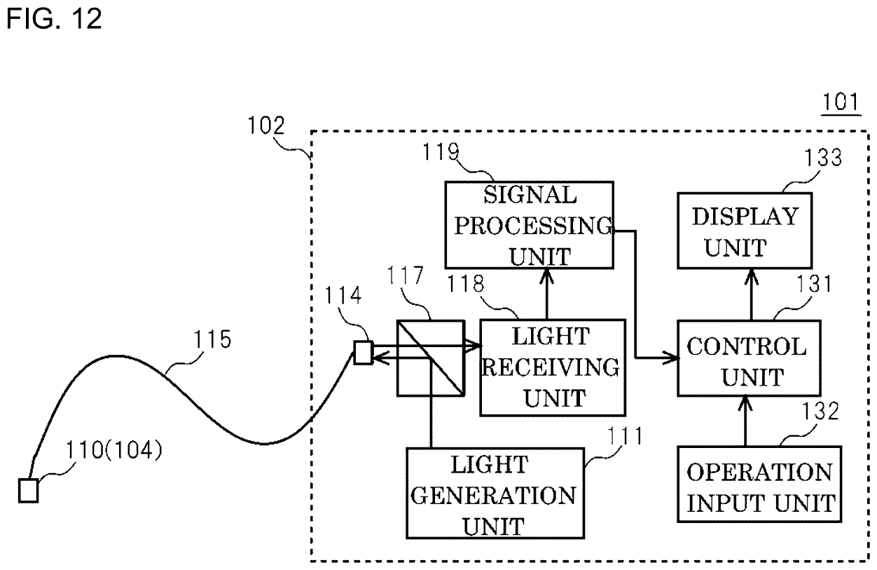

Next, a second embodiment will be described with reference to FIGS. 11 and 12. The method of forming the irradiation beam differs from that of the first embodiment described above. In FIG. 11 and subsequent figures, components corresponding to those in the first embodiment are assigned reference numerals obtained by adding 100, and descriptions of the same components are omitted for brevity.

In FIG. 11, reference numeral 110 indicates a disk-shaped Bessel beam generating device. In the disk-shaped Bessel beam generating device 110, after a laser beam incident as diverging light is reflected outward, it is reflected from outside to inside, so that an irradiation beam having a donut-shaped cross-section is emitted.

An entrance portion 115 emits a laser beam and directs it into a lens 116. The entrance portion 115 may be, for example, a light source, an optical fiber, or another optical component; in general it denotes the component or element positioned upstream of the lens 116.

The lens 116 adjusts the divergence angle of the laser beam and directs the laser beam into an adjacent reflective cover portion 126. The reflective cover portion 126 has a shape, for example, of a part cut out from a spherical or ellipsoidal surface, and a reflective coating is formed on its entire surface except the area where it contacts the lens 116. Hereinafter, when laser light is incident on the reflective cover portion 126, the propagation direction of the optical axis at that time is called the forward direction Z_P of the laser light, and the backward direction is called the return direction Z_B.

The reflective cover portion 126 has an inner surface shaped as a portion of a sphere, ellipsoid, or parabolic surface (a high-order function curved surface). It transmits the incident laser light without alteration and directs it onto the reflective lens 125. The reflective lens 125 has a pointed shape, with a circular cross-section in the XY plane (for example, a conical shape). A reflective coating is formed on the side of the reflective lens 125 on which the laser light is incident.

The reflective lens 125 reflects the incident laser light outward (preferably at an angle of 80° to 170° relative to the forward direction Z_P of the laser light). The reflective cover portion 126 reflects the laser light inward.

Here, by the outward reflection by the reflective lens 125 and the inward reflection by the reflective cover portion 126, the laser beam becomes an irradiation beam directed inward. At this time, light that was near the optical axis before incidence on the reflective lens 125 becomes the outer portion after reflection, and light that was at the outer portion before incidence on the reflective lens 125 becomes the inner portion after reflection.

Therefore, low-intensity light overlaps at a nearer position, and high-intensity light overlaps at a farther position to form a focal point. This makes it possible to compensate for attenuation before the focal point by the intensity distribution of the laser light.

Note that by mounting the lens 116 so that it can be tilted relative to the entrance portion 115 (i.e., making it rotatable), it is also possible to adjust the irradiation direction of the disk illumination beam.

### Configuration of Optical Scanning Device

Next, the configuration when the disk-shaped Bessel beam generating device 110 is used as an OCT (Optical Coherence Tomography) apparatus (optical scanning device) will be described.

As shown in FIG. 12, an OCT apparatus 101 includes an external device 102, an entrance portion 115 which is an optical fiber, and the disk-shaped Bessel beam generating device 110. The disk-shaped Bessel beam generating device 110 is attached to the tip of the entrance portion 115 (optical fiber).

The external device 102 is provided with a control unit 131 composed of an MPU, ROM, and RAM, which integrally controls the entirety of the external device 102.

In addition to an operation input unit 132 and a display unit 133, the external device 102 includes, as compared to the first embodiment where those components were in the measurement unit 4, a light generation unit 111, an optical branching unit 117, an entrance portion 114, a light receiving unit 118, and a signal processing unit 119.

Thus, in the OCT apparatus 101 using the disk-shaped Bessel beam generating device 110, because the number of components is small, the tip portion (measurement device 104) can be miniaturized (for example, to about a 1 mm square). This makes it suitable for applications such as catheters for imaging the interior of blood vessels.

The light generation unit 111 splits a pulse beam modulated by an optical comb and, after adjusting optical path lengths, supplies it as a reference light beam to the light receiving unit 118. The light receiving unit 118 receives the return light beam and the reference light beam, and supplies them as a measurement signal and a reference signal, respectively, to the signal processing unit 119.

### INDUSTRIAL APPLICABILITY

### Operation and Effects

The features of the groups of inventions extracted from the above embodiments will be described below, with the problems and effects as needed. Note that for ease of understanding, in the following description, the corresponding components in the above embodiments are appropriately indicated in parentheses or the like, but the invention is not limited to the specific configurations indicated in such parentheses. In addition, the meanings, examples, etc. of terms described in each feature may also be applied as meanings or examples of terms described in other features that use the same wording.

According to the above configuration, in the Bessel beam generating device (disk-shaped Bessel beam generating device 10) of the present invention:
a group of optical fibers (optical fiber 15) comprising at least four optical fibers or more (32 optical fiber 15) is arranged such that their tips (fiber tip 15A) are on the same circle at equal intervals, and each said fiber tip is arranged such that it is tilted at the same angle with respect to the diameter direction of the circle;
an entrance portion (entrance portion 14) is provided that causes split beams obtained by splitting a laser beam from a single light source to enter each of the optical fibers; and
a lens (lens 16) is provided which adjusts the beam of light emitted from each said optical fiber so that diverging light with a donut-shaped cross-section having a hollow center that travels inward (toward the circle's center) is emitted as a disk illumination beam from the group of optical fibers.

In a conventional Bessel beam generating device using an axicon lens, it was difficult to adjust the focal length. Also, in a Bessel beam generating device that blocks the central portion of the beam, it was necessary to block the central portion where the light intensity is highest, and therefore a significant reduction in light intensity was unavoidable.

In the Bessel beam generating device of the present invention, because it can generate a donut-shaped Bessel beam with almost no reduction in light intensity and with an arbitrary radius and divergence angle, the focal length and depth of focus can be set freely. In this Bessel beam generating device, the attenuation can be compensated by a high light intensity, so the irradiation beam can reach deep positions from the surface of the material to be irradiated.

In the Bessel beam generating device, the lens is configured to irradiate the beams such that the divergence angle of the irradiation beam differs between the circumferential direction and the diameter direction of the circle.

This allows the distance between adjacent optical fibers (i.e., the circle's radius) to be set freely in the Bessel beam generating device, and therefore the degree of freedom in design can be improved.

In the Bessel beam generating device, the fiber tip is arranged tilted inward with respect to the diameter direction of the circle.

This allows the focal length to be determined by the tilt angle of the fiber tips in the Bessel beam generating device, meaning that thereafter only the divergence angle needs to be adjusted. Therefore, the degree of freedom in designing the lens that emits the irradiation beam is improved.

In the Bessel beam generating device, each said optical fiber is provided with a voltage applying device (voltage applying unit 21) for temporally advancing or delaying the wavefront of the emitted light.

This allows the focal position of the disk illumination beam in the Bessel beam generating device to be moved in a direction perpendicular to the optical axis of the disk illumination beam.

In the Bessel beam generating device, a movable part (lens driving unit 22) is provided that can rotate the lens.

This allows the focal position of the disk illumination beam in the Bessel beam generating device to be moved along the optical axis direction of the disk illumination beam.

In the optical scanning device (OCT apparatus 1) of the present invention:
a light source (the light source in the light generation unit 11) that emits a laser beam;
a beam splitting unit (beam splitting unit 13) that generates split beams by splitting a laser beam emitted from a single light source;
a group of optical fibers (optical fiber 15) comprising at least four optical fibers or more (32 optical fiber 15) arranged such that their tips (fiber tip 15A) are on the same circle at equal intervals, each said fiber tip being arranged such that it is tilted at the same angle with respect to the diameter direction of the circle;
an entrance portion (entrance portion 14) that causes the split beams to enter each of the optical fibers;
a lens (lens 16) that adjusts the beam of light emitted from each said optical fiber so that diverging light with a donut-shaped cross-section having a hollow center that travels inward is emitted from the group of optical fibers as a disk illumination beam;
a light receiving unit (light receiving unit 18) that receives a return light beam reflected from the disk illumination beam and converts it into an electrical signal; and
an analysis unit (control unit 31) that calculates the position of a reflection point of the measurement object by analyzing the electrical signal.

This allows the focal length and depth of focus to be set large in the optical scanning device, so that deeper positions from the surface can be scanned, and even without moving the focus, the shape or other attributes of the object over a wide range in the optical axis direction can be observed.

In the Bessel beam generating device (disk-shaped Bessel beam generating device 110) of the present invention: a reflective lens (reflective lens 125) that reflects an incident laser beam outward from the optical axis; and a reflective cover portion (reflective cover portion 126) arranged to cover the reflective lens and that reflects the laser beam traveling outward toward the inside are provided.

This allows the laser beam to be expanded once and then reflected inward in the Bessel beam generating device, making it possible to generate a donut-shaped Bessel beam with virtually no reduction in light intensity and with an arbitrary radius and divergence angle, and thus the focal length and depth of focus can be set freely.

Furthermore, by two reflectors, the high-intensity central portion of the laser beam can be moved outward, and the low-intensity outer portion of the laser beam can be moved to the center, thereby inverting the intensity distribution in the beam such that the farther out, the higher the intensity of the light in the donut-shaped Bessel beam. In this Bessel beam, the focal distance is shorter on the inner side and longer on the outer side, so that the light intensity is increased for the outer portions where attenuation is greater, allowing the disk illumination beam to reach far distances despite attenuation.

In the Bessel beam generating device, the reflective lens is configured to reflect the incident laser beam so that the beam travels toward the outside of the optical axis.

This prevents the laser light reflected by the reflective lens from mixing into the return light beam in the Bessel beam generating device, thus minimizing the reduction in light intensity and reducing noise mixed into the return light beam as much as possible.

In the Bessel beam generating device, the reflective lens has a conical shape with an apex angle of 90°.

This allows the laser light to be bent by at least 90° relative to the optical axis of the disk illumination beam in the Bessel beam generating device, preventing the laser light from being reflected back in the return direction of the disk illumination beam's optical axis (the opposite direction of propagation). In addition, having a conical shape ensures that essentially all of the laser light is converted into the disk illumination beam without loss.

In the optical scanning device (OCT apparatus) of the present invention:
a light source (the light source in the light generation unit 111) that emits a laser beam;
a reflective lens (reflective lens 125) on which the laser beam is incident and which reflects the laser beam outward from the optical axis;
a reflective cover portion (reflective cover portion 126) arranged to cover the reflective lens and that reflects the laser beam traveling outward toward the inside;
a light receiving unit (light receiving unit 118) that receives the return light beam reflected from the disk illumination beam and converts it into an electrical signal; and
an analysis unit (control unit 131) that calculates the position of a reflection point of the measurement object by analyzing the electrical signal are provided.

This means that the optical scanning device can use a disk illumination beam capable of reaching far distances despite attenuation, so for example, the interior of a blood vessel or deep inside a human body can be scanned, enabling observation of measurement targets that could not be observed with prior OCT devices.

### Third Embodiment

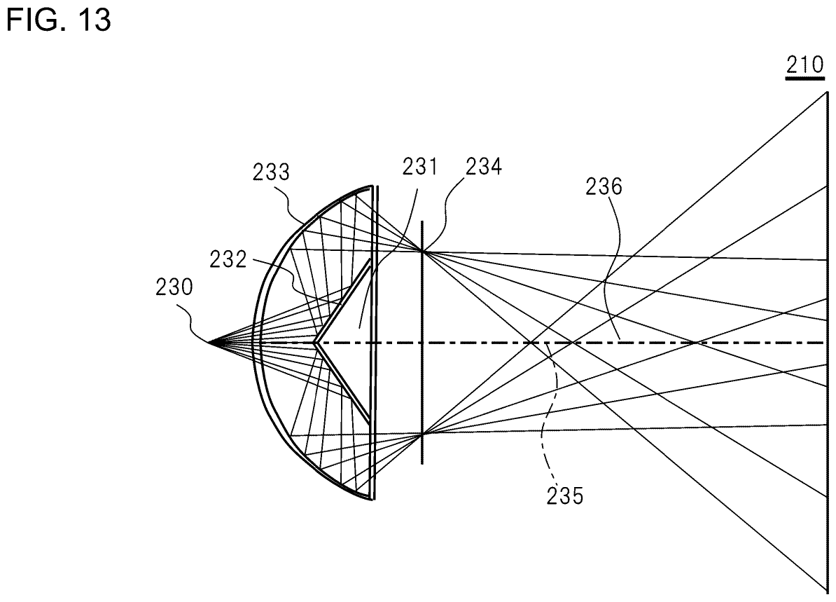

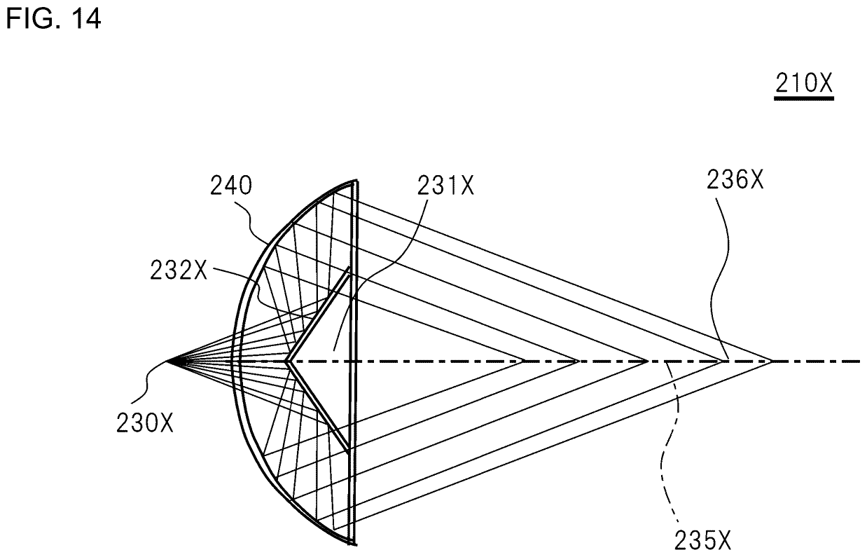

Next, a third embodiment will be described with reference to FIGS. 13 and 14. The configuration of the disk-type Bessel beam generating device 210 differs from that of the second embodiment described above. In the third embodiment, descriptions of the same components as in the second embodiment are omitted.

As shown in FIG. 13, in the disk-type Bessel beam generating device 210, a laser beam emitted from a micro light source 230 having directivity in a Cassegrain antenna configuration is reflected by the generatrix 232 of conical sub-reflector 231 whose axis is the optical axis 235 of the laser beam. The conical sub-reflector 231 is configured such that a ring-shaped virtual light source formed around the sub-reflector 231 by the reflected laser beam (the extended line of the laser traveling toward an elliptical main reflector 233) is located at the first focus of the ellipse.

After that, the laser beam reflected by the elliptical main reflector 233 is gathered in a ring shape at the second focus 234 of the ellipse on the elliptical main reflector 233. A ring-shaped directional light source is formed at the second focus 234 on the major axis of the ellipse, thereby generating a modified Bessel beam. In other words, the elliptical main reflector 233, the micro light source 230, and the conical sub-reflector 231 are configured such that the first focus and second focus 234 of the elliptical main reflector 233 serve as a virtual light source and a directional light source, respectively.

Furthermore, by making the generatrix 232 of the conical sub-reflector curved (convex or concave) instead of straight, the position of the virtual light source (i.e. the position of the first focus of the ellipse) can be changed. This increases the degree of freedom in designing the elliptical main reflector 233, and as a result, the effective range of the Bessel beam can be modified.

Also, as shown in FIG. 14, in a disk-type Bessel beam generating device 210X, if the main reflector 240 is made not an elliptical surface but a parabolic surface or an aspherical (free-form) surface, the laser light from the main reflector 240 becomes parallel rays, slightly diverging rays, or rays with a focal point beyond the effective range of the Bessel beam. In this way, a Bessel beam can be generated that is closer to the Bessel beam produced by an axicon lens. In FIG. 14, components corresponding to those in FIG. 13 are denoted with the same reference numerals plus “X”.

According to the above configuration, in the modified Bessel beam generating device (disk-shaped Bessel beam generating device 210) of the present invention:
a group of at least four light emitters (32 optical fiber 15) is arranged at equal intervals on the same circle such that light is emitted from the tip of an optical waveguide portion, with the optical axis of the light emitted from each said light emitter maintained at the same angle with respect to the diameter direction of the circle;
an entrance portion (entrance portion 14) that splits a laser beam emitted from a single light source and causes the split light to enter each of the optical waveguide portions; and
an optical waveguide portion (lens 16) having a function to make the phase and amplitude of the emitted light identical at each said light emitting portion are provided.

In the modified Bessel beam generating device, each said light emitter has on its front side an optical axis adjustment lens for adjusting the angle between the optical axis of the emitted light and the diameter direction of the circle.

In the modified Bessel beam generating device, each said optical waveguide portion is provided with a phase/amplitude adjustment device for varying the wavefront of the emitted light spatially or temporally.

In the modified Bessel beam generating device, a rotationally symmetric conical reflector whose generatrix is linear or curved is provided to reflect the incident laser beam outward from the optical axis, and a reflective cover portion is arranged to cover the conical reflector and re-reflects the reflected wave from the conical reflector by means of an elliptical main mirror having the optical axis as its axis of rotational symmetry.

In the modified Bessel beam generating device, the reflective cover portion re-reflects the reflected wave by means of a parabolic main mirror having the optical axis as its axis of rotational symmetry.

### Other Embodiments

In the above embodiments, although not described in detail, by performing frequency modulation on the laser light using an M-sequence code or other PN code (Pseudo Random Noise), it is possible to reduce noise and improve the measurement resolution. Specifically, a coherent continuous light is generated by the light source, and the continuous light is converted into a periodic train of optical pulses with low interference between adjacent pulses. The optical pulse train is phase-modulated with a two-phase modulation using a code having an autocorrelation property (a PN code such as an M-sequence), and one of the split optical pulse trains is frequency shifted. One of the split optical pulse trains is used as an illumination optical system for irradiating the measurement object, and the other split optical pulse train's optical path length is adjusted to be the same as that of the measurement optical system and used as a reference optical system. A photodetector receives the optical pulse train output from the reference optical system and the return light from the measurement optical system. Based on the optical signal received by the photodetector, a difference signal having the shift frequency of the frequency shifter as a beat frequency of the backscattered wave from the measurement object is extracted by a filter. The filter's output and a reference signal synchronized with the frequency shifter's shift frequency are combined and demodulated by a demodulator. The signal output by the demodulator is analyzed by the analysis unit to calculate the positions of reflection points of the measurement object. The detailed configuration is described in WO 2019/017392.

In the first embodiment described above, the beam splitting unit 13 is composed of an arrayed-waveguide grating or the like, but the present invention is not limited to this. For example, a doughnut-shaped beam may be formed by using an inverse axicon lens having an overall conical concave shape with a bulging slope (i.e., a shape that mates with a narrowing conical shape), and made to enter the ring-arranged optical fiber 15. In other words, the light beam is split at the stage of being coupled into the optical fiber 15. In this case, the inverse axicon lens serves the roles of the beam splitting unit 13 and the entrance portion 14.

In the second embodiment described above, only the disk-shaped Bessel beam generating device 110 is attached to the tip of the optical fiber 105, but the present invention is not limited to this. For example, the light source and the light receiving unit can be attached together with the disk-shaped Bessel beam generating device 110 as a tip assembly, and the exchange of electrical signals can be performed between the tip assembly and an external device.

Furthermore, although not specifically mentioned in the above embodiments, devices such as a distance measuring device (e.g., an accelerometer) capable of measuring movement distance, or a position specifying device that can determine the position of the disk-shaped Bessel beam generating device, may be added to the disk-shaped Bessel beam generating device. This enables accurate determination of the position of the disk-shaped Bessel beam generating device and can improve the accuracy of image processing. Even if such devices are not present, by identifying the same positions in image processing or calculating motion vectors, it is possible to composite images when the disk-shaped Bessel beam generating device has scanned.

Also, in the above embodiments, it is possible to configure a single probe by combining and fixing multiple disk-shaped Bessel beam generating devices, or to perform simultaneous imaging from multiple directions by using multiple disk-shaped Bessel beam generating devices. This enables a wider range to be measured in a single measurement and can be expected to further improve accuracy.

In the above embodiments, an optical fiber was used as the optical waveguide portion, but the present invention is not limited to this. For example, the disk-shaped Bessel beam generating device may be implemented as an integrated photonic optical circuit, and various waveguides such as those in silicon photonics can be used as the optical waveguide portion.

The disk-shaped Bessel beam generating device can also be configured such that a laser beam emitted from a micro light source with directivity in a Cassegrain antenna configuration is reflected by a conical sub-reflector (with the optical axis of the laser beam as its axis of symmetry) to create a ring-shaped virtual light source around the sub-reflector, and light from this virtual light source is reflected by a rotating elliptical surface main reflector, so that on the major axis of the ellipse an actual focal point is formed where light is gathered in a ring shape. In this way, a ring-shaped directional light source is formed, and a modified Bessel beam is generated.

Further, in the Bessel beam generating device of the present invention, a laser beam emitted from a micro light source with directivity in a Cassegrain antenna configuration can be incident, the laser beam's optical axis being the axis of symmetry of a conical sub-reflector, such that a ring-shaped virtual light source is formed around the sub-reflector. Light from this virtual light source is reflected by a rotating parabolic surface main reflector to re-reflect the beam, generating a conical wavefront with an apex angle that is nearly an obtuse angle close to 180 degrees. These conical wavefronts are phase-combined on the optical axis to generate a Bessel beam.

Note that the reason for using an elliptical surface as the main reflector is that a ring-shaped circle is formed at the focus of an ellipse. When a ring-shaped circle is formed, the side lobes around the Bessel beam due to the Fresnel zone are reduced.

In the second embodiment, for the inner rays with a large angle, the peripheral portion of the light emitted from the fiber (where the center portion is strong and the periphery is weaker) forms the nearest Bessel beam, and the strong central portion of the light forms a beam at a farther location. This offsets the attenuation of light in human tissue, making it suitable for use in, for example, a catheter that measures inside blood vessels.

### INDUSTRIAL APPLICABILITY

The present invention can be used, for example, in an OCT apparatus for medical use to observe inside the body of a human or animal, or for detecting defects such as scratches in paint.

### REFERENCE SIGNS LIST

1, 101: OCT apparatus
2, 102: external device
4, 104: measurement unit
10, 110: disk-shaped Bessel beam generating device
11, 111: light generation unit
12: collimation unit
13: beam splitting unit
14, 114: entrance portion
15: optical fiber
15A: fiber tip
16: lens
17: optical branching unit
18, 118: light receiving unit
19, 31, 131: control unit
21: voltage applying unit
22: lens driving unit
23: external interface
119: signal processing unit
125: reflective lens
126: reflective cover portion
131: control unit

The invention claimed is:

1-8. (canceled)

9 : A modified Bessel beam generating device, comprising:
a light source that emits a laser beam;
an optical fiber into which the laser beam emitted from the light source is introduced;
and a lens that, by adjusting the light flux of an irradiation beam emitted from the optical fiber, produces diverging light having a ring-shaped cross-section with a hollow center that travels toward the inside of the ring and emits it from the optical fiber as a disk illumination beam;
wherein the lens includes a reflective lens that reflects the incident laser light outward from the optical axis, and a reflective cover portion arranged to cover the reflective lens and that reflects the laser light traveling outward toward the inside;
and wherein the reflective cover portion inverts the laser light traveling outward such that light located on the inner side becomes outer and light located on the outer side becomes inner;
whereby a Bessel beam generating device is provided.

10: The modified Bessel beam generating device according to claim 9,
wherein the reflective lens is a rotationally symmetric conical reflector whose generatrix is linear or curved and that reflects the incident laser light outward from the optical axis, and the reflective cover portion is arranged to cover the conical reflector and re-reflects the reflected wave from the conical reflector with a surface that is a portion cut out from a spherical surface, an ellipsoidal surface, or a higher-order parabolic surface, or a free-form surface, such that light of higher intensity overlaps at a farther position to form a focus.

11: The modified Bessel beam generating device according to claim 10,
wherein the reflective cover portion has a surface formed by rotating an ellipse or a parabola about the optical axis, which re-reflects the reflected wave.

12: An optical scanning device, comprising:
a light source that emits a laser beam; an optical fiber into which the laser beam emitted from the light source is introduced;
a lens (including a reflective lens and a reflective cover portion) that, by adjusting the light flux of the irradiation beam emitted from the optical fiber, produces diverging light having a ring-shaped cross-section with a hollow center that travels toward the inside of the ring and emits it as a disk illumination beam, the lens including a reflective lens that reflects the incident laser light outward from the optical axis and a reflective cover portion that is arranged to cover the reflective lens and reflects the laser light traveling outward toward the inside;
a light receiving unit that receives return light when the disk illumination beam is irradiated onto a measurement target and converts it into an electrical signal;
and an analysis unit that calculates the position of a reflection point of the measurement target by analyzing the electrical signal;
wherein the reflective cover portion inverts the laser light traveling outward such that light located on the inner side goes outward and light located on the outer side goes inward.
